(19) United States
(12) Patent Application Publication
(10) Pub. No.: US 2020/0032653 A1
(43) Pub. Date: Jan. 30, 2020

(54) RETENTION OF A ROTOR OF AN ELECTRONICALLY-CONTROLLED TURBOMACHINE

(71) Applicant: BorgWarner Inc., Auburn Hills, MI (US)

(72) Inventors: Tyler Garrard, Arden, NC (US); Christopher Meszaros, Brighton, MI (US); Will Robert Nielsen Hippen, Santa Cruz, CA (US)

(21) Appl. No.: 16/505,108

(22) Filed: Jul. 8, 2019

Related U.S. Application Data
(62) Division of application No. 15/024,599, filed on Mar. 24, 2016, now abandoned.
(60) Provisional application No. 61/895,632, filed on Oct. 25, 2013.

(51) Int. Cl. F01D 5/02; F04D 29/05; F01D 5/04; F01D 25/16; F01D 15/10

(52) U.S. Cl. CPC F01D 5/025; F05D 2260/30; F01D 5/048; F01D 25/166; F01D 15/10; F05D 2220/76; F05D 2230/60; F05D 2240/60; F05D 2250/281; F05D 2250/292; F05D 2220/40; F05D 2230/10; F05D 2230/20; F05D 2230/31; F05D 2230/90; F04D 29/05

(57) ABSTRACT

An electronically-controlled turbocharger (ECT) includes a shaft having a turbine wheel affixed thereto at or adjacent to one end thereof, a retaining feature in the form of a shoulder or a plurality of splines defined radially about the shaft between the turbine wheel and an end of the shaft opposite the one end thereof, a rotor of an electric motor received on the shaft with one end of the rotor facing the turbine wheel configured complementary to and engaging with the retaining feature, and a retaining element affixed to the shaft and abutting the rotor on an end of the rotor opposite the one end thereof.

### CROSS-REFERENCE TO RELATED APPLICATIONS

This is a division of U.S. patent application Ser. No. 15/024,599, filed Mar. 24, 2016, which is a U.S. national phase of International Application No. PCT/US2014/062301, filed Oct. 25, 2014, which claims the benefit of, and priority to, U.S. Patent Application Ser. No. 61/895,632, filed Oct. 25, 2013, the disclosures of which are expressly incorporated herein by reference.

### FIELD

The present disclosure relates to retaining a rotor of an electric motor onto a turbocharger shaft.

### BACKGROUND

An electronically-controlled turbomachine (ECT) includes an electric machine (or motor) mounted between the turbine and compressor sections. The turbomachine rotates at speeds up to 350,000 rpm. The rotor of the electric machine should be mounted to resist relative rotation between the rotor and the turbocharger shaft. The rotor may be press fit onto the shaft as described in commonly-assigned international patent application PCT/US2014/017455 filed Feb. 20, 2014, which is incorporated herein in its entirety. However, the press fit may prevent disassembly and servicing of the ECT. An ECT and assembly technique that allows disassembly of the rotor from the ECT shaft is desired.

### SUMMARY

To overcome at least one problem in the prior art, an ECT is disclosed that includes a shaft having a turbine wheel coupled thereto. The shaft has a retaining feature defined on the shaft. The ECT further includes a rotor of an electric motor placed onto the shaft. A core of the rotor (rotor core) has an end proximate the turbine wheel that engages with the retaining feature. A retaining element engages with the shaft and abuts with the rotor core on an end of the rotor core distal from the turbine wheel.

In one embodiment, the retaining feature is a shoulder machined into the shaft. An end of the rotor core proximate the turbine wheel is substantially perpendicular to a central axis of the shaft and the end of the rotor core proximate the turbine wheel abuts the shoulder. In some embodiments, at least one of a surface of the shoulder and the end of the rotor core proximate the turbine wheel is roughened by one of: knurling, bead blasting, etching, sand blasting, laser vapor deposition, laser etching, and applying a coating.

In another embodiment, the retaining feature is an exterior taper on the shaft with a diameter of the taper decreasing monotonically in a direction moving away from the turbine wheel. An end of the rotor core that engages with the taper has an interior taper section which mates with the exterior taper and the interior diameter of the interior taper decreases monotonically in a direction moving away from the turbine wheel. At least one of the interior and exterior tapers is roughened by one of: knurling, bead blasting, etching, sand blasting, laser vapor deposition, laser etching, and applying a coating.

In yet another embodiment, the retaining feature includes a plurality of splines defined in the shaft. The shaft diameter on the turbine wheel side proximate the splines are substantially equal to the outside diameter of the splines. The shaft diameter away from the turbine wheel side proximate the splines are substantially equal to the inside diameter of the splines. The rotor core has a plurality of fingers that mate with the splines of the shaft. In some embodiments, the rotor core includes a stiffener sleeve. In other embodiments, the permanent magnets of the rotor sit against the shaft with end caps on either end. In this embodiment, it is an end cap that abuts with the nut or an end cap which mates with the retaining feature.

In some embodiments, the shaft includes threads defined therein along a portion of the length of the shaft and the retaining element is a nut that engages with the threads. At least one of a surface of the nut that abuts the rotor or a surface of the rotor that abuts the nut is roughened by one of: knurling, bead blasting, etching, sand blasting, laser vapor deposition, laser etching, and applying a coating.

In other embodiments, the retaining element is a collar that is press fit onto the shaft. The collar may be a sacrificial element that is destroyed in disassembling the rotor from the shaft.

A method to assemble an ECT is disclosed that includes: installing turbine-side labyrinth oil seals onto a shaft of the ECT; installing a turbine-side journal bearing on the shaft; sliding a rotor of an electric machine onto the shaft; and securing a retaining element onto the shaft with the retaining element abutting the rotor. In embodiments in which the retaining element is a nut, the method further includes engaging the threads of the nut with threads machined on the shaft and torquing the nut to a predetermined torque. In embodiments in which the retaining element is a collar, the method further includes: sliding the collar onto the shaft and press fitting the collar onto a portion of the shaft proximate the rotor. In some embodiments with a collar, at least one of the following is performed prior to sliding the collar onto the shaft: heating the collar and cooling the shaft.

The method further includes installing the turbine shaft into a housing prior to sliding the rotor onto the shaft.

Also disclosed is an ECT having a shaft of the ECT having a turbine wheel welded onto a first end of the shaft and a retaining feature defined on the shaft, a rotor of an electric motor placed over the shaft with an end of the rotor proximate the turbine wheel engaging with the retaining feature, and a retaining element affixed to the shaft abutting the rotor on an end of the rotor distal from the turbine wheel.

The retaining feature may be a shoulder machined into the shaft. An end of the rotor proximate the turbine wheel is substantially perpendicular to a central axis of the shaft and the end of the rotor proximate the turbine wheel abuts the shoulder.

The retaining feature may be an exterior taper on the shaft with a diameter of the taper decreasing monotonically in a direction moving away from the turbine wheel. An end of the rotor that engages with the taper has an interior taper section that mates with the exterior taper. The interior diameter of the interior taper decreases monotonically in a direction moving away from the turbine wheel.

The shaft may include threads defined therein along a portion of the length of the shaft and the retaining element is a nut that engages with the threads.

The retaining element may be a collar that is press fit onto the shaft.

The rotor may include a rotor core that engages with the shaft. The rotor may be a portion of a permanent magnet motor having permanent magnets that are installed against an outer surface of the rotor core. Alternatively, the rotor is a permanent magnet motor and the permanent magnets are installed against the shaft.

### BRIEF DESCRIPTION OF THE DRAWINGS

FIG. 1 is a cross-sectional view of an ECT;

FIGS. 2 and 3 are cross-sectional views of ECT shafts according to embodiments of the disclosure;

FIGS. 4 and 5 show an embodiment of an ECT shaft prior to assembly of the rotor and after assembly, respectively;

FIG. 6 is a flowchart illustrating fabrication processes which the ECT may be assembled;

FIGS. 7-11 illustrate assembly processes related to FIG. 6; and

FIG. 12 shows an alternative rotor in which permanent magnets are mounted directly onto the shaft.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

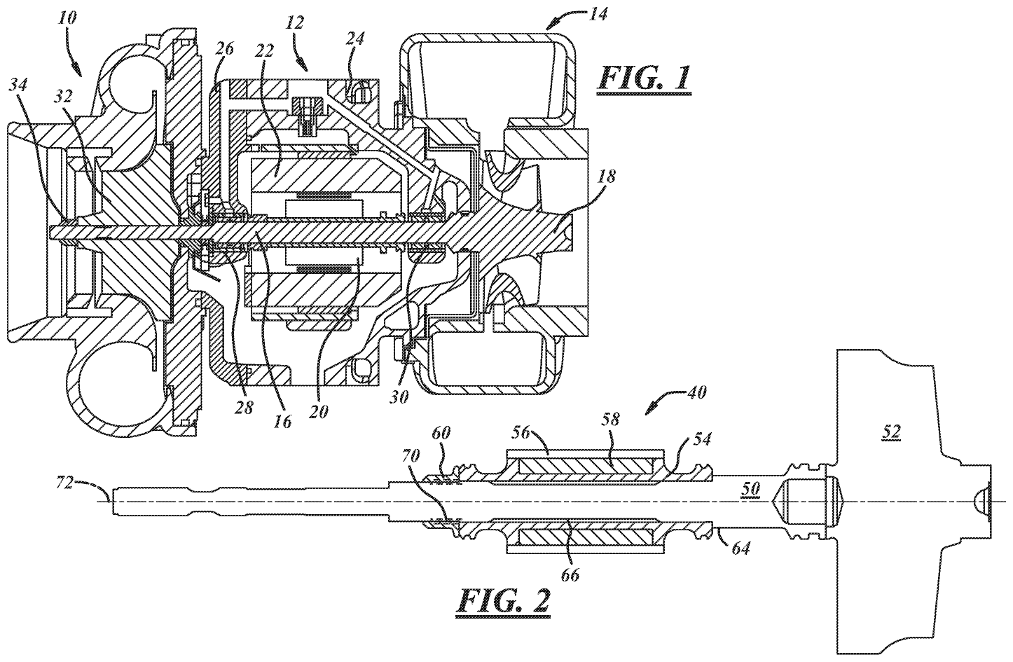

ECT herein is used to denote both electronically-controlled turbocharger and electronically-controlled turbomachine, two names for the same component. In FIG. 1, an ECT is shown in cross section. The ECT has a compressor section 10, an electric machine section 12, and a turbine section 14. A shaft 16 passes through sections 10, 12, and 14. A turbine wheel 18 is affixed to shaft 16 by welding, by mechanical fasteners, or any other suitable manner of coupling two members.

Electric machine section 12 includes an electric machine that includes a rotor 20 and a stator 22 enclosed within two housing portions: a turbine-side housing portion 24 and a compressor side housing portion 26. The electric machine can be operated as either a motor, in which electrical energy is applied to the motor to cause the shaft to rotate faster than it would otherwise, or as a generator, in which an electrical load is applied to the motor to cause the shaft to rotate slower than it would otherwise. The terms electric machine, motor, and generator are used herein interchangeably with the understanding that depending on the embodiment, the electric machine may be operated as a motor, generator, or neither if no electric current is applied to windings associated with the rotor. In some embodiments, the electric machine may be adapted to operate only as a motor or only as a generator. Journal bearings 28 and 30 are disposed in housing portions 26 and 24, respectively, to support shaft 16. Considered axially, journal bearing 30 is located between rotor 20 and turbine section 14 and journal bearing 28 is located between rotor 20 and compressor section 10.

A compressor wheel 32 is provided on the end of shaft 16 distal from turbine wheel 18. Compressor wheel 32 is held onto shaft 16 via a nut 34 in the embodiment of FIG. 1. The compressor wheel 32 is typically manufactured from a light alloy dissimilar from the turbo shaft 16 preventing a weldment. Compressor wheel 32 is typically secured onto the shaft via a fastener or threaded feature.

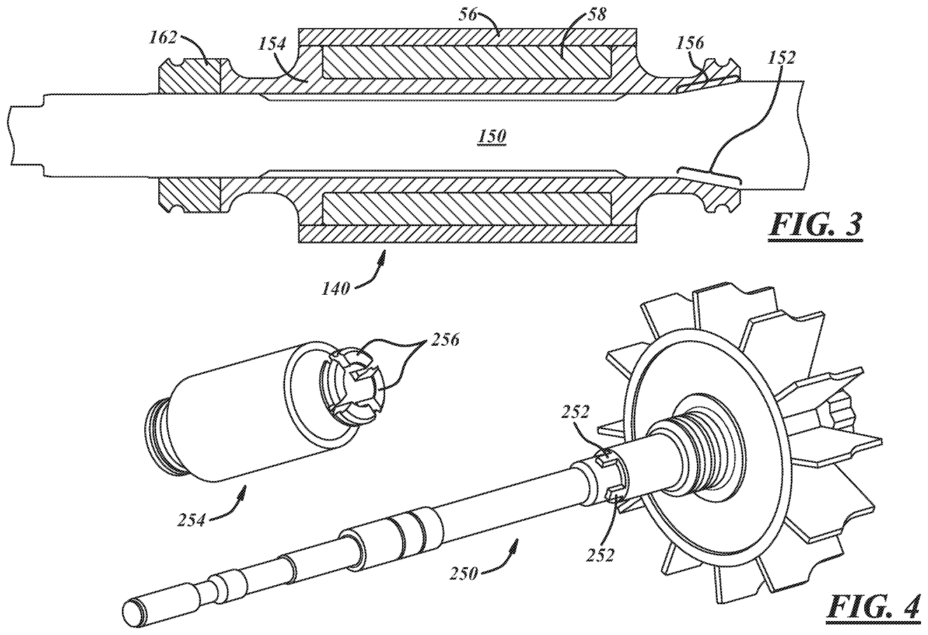

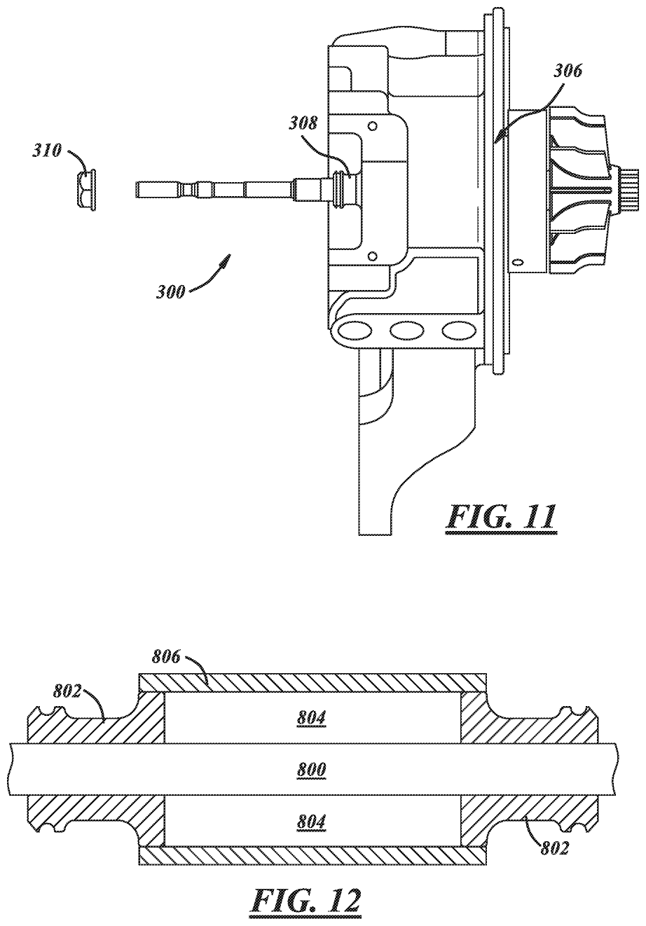

In FIG. 2, a shaft 50 is welded to a turbine wheel 52. A rotor core 54 of a rotor 40 is placed over shaft 50. Permanent magnets 58 surround rotor core 54 with an outer containment sleeve 56 containing permanent magnets 58. (In the present embodiment, the rotor core is a stiffener sleeve. In other embodiments, the permanent magnets sit on the shaft, as described below in regards to FIG. 12.) Rotor core 54 is shown in FIG. 2 as a single piece. However, the rotor core may be made up of a plurality of sections, such as a center section and two end caps. Shaft 50 has threads 70. Nut 60 engages with threads 70. An end of rotor core 54 proximate turbine 52 is squared off and bears against a shoulder 64 in shaft 50. In the embodiment in FIG. 2, there is an undercut near shoulder 64. Shaft 50 is cut back along a recessed portion 66 in the center of the engagement of rotor core 54 and shaft 50. In alternative embodiments, the shaft is not cut back.

The embodiment in FIG. 2 shows a rotor of a permanent magnet electric motor. However, this is not intended to be limiting. A rotor of any suitable electric motor may be placed on shaft 50.

In various embodiments, some mating surfaces may be roughened to increase friction to resist disassembly. The mating surfaces may be roughened by laser surface treatments, sand blasting, knurling, ball peening or any other suitable technique. In one embodiment, at least one of the end of the rotor core 54 proximate turbine 52 and the shoulder 64 has roughened surfaces. In one embodiment, at least one of: the surface of nut 60 proximate rotor core 54 and the end of rotor core 54 away from turbine wheel 52 is roughened.

In an alternative embodiment shown in FIG. 3, a shaft 150 has a rotor core 154 of a rotor 140 placed over shaft 150. Permanent magnets 58 surround rotor core 154 with an outer containment sleeve 56 restraining permanent magnets 58. Shaft 150 has an exterior taper 152 and rotor core 154 has an interior taper 156 with both tapers 152 and 156 decreasing as considered in a direction away from turbine wheel (not shown in FIG. 3, but would be on the left hand side of FIG. 3). A collar 162 is press fit onto shaft 150. In one embodiment, collar 162 is partially cut to allow it to be removed, i.e., collar 162 is sacrificed in disassembly to permit servicing. Alternatively, collar 162 can be removed. In yet another embodiment, collar 162 is not intended to be removed, i.e., a one-time assembly.

In some embodiments, at least one of the region of the shaft 150 in which collar 162 engages and an interior surface of collar 162 is roughened. In some embodiments, at least one of interior taper 156 and exterior taper 152 is roughened. In some embodiments, at least one of the bearing surfaces between collar 162 and rotor core 154 is roughened.

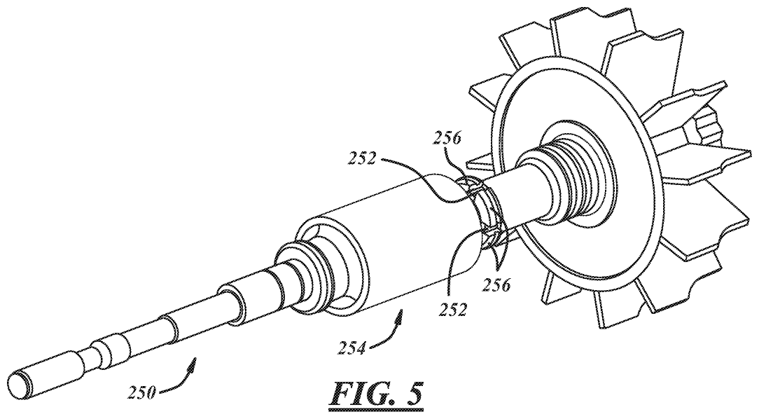

In an embodiment shown in FIG. 4, a shaft 250 is provided with a plurality of splines 252 and a rotor 254 (may be the rotor core associated with rotor 254) is provided with a plurality of fingers 256 that engage with splines 252. In FIG. 5, rotor 254 is shown slid over shaft 250 with finger 256 engaged with splines 252.

Several alternatives have been described above for retaining the rotor onto the shaft including at least: tapers, a shoulder, splines, a nut, and a collar. Further, many examples of surfaces that may be roughened to prevent relative rotation of adjacent members. And, many types of electric motors may be used in place of the permanent magnet motor disclosed herein. Not every suitable combination has been illustrated in the drawings. The drawings are not intended to be limiting and additional combinations than those explicitly shown and described are within the scope of the disclosure.

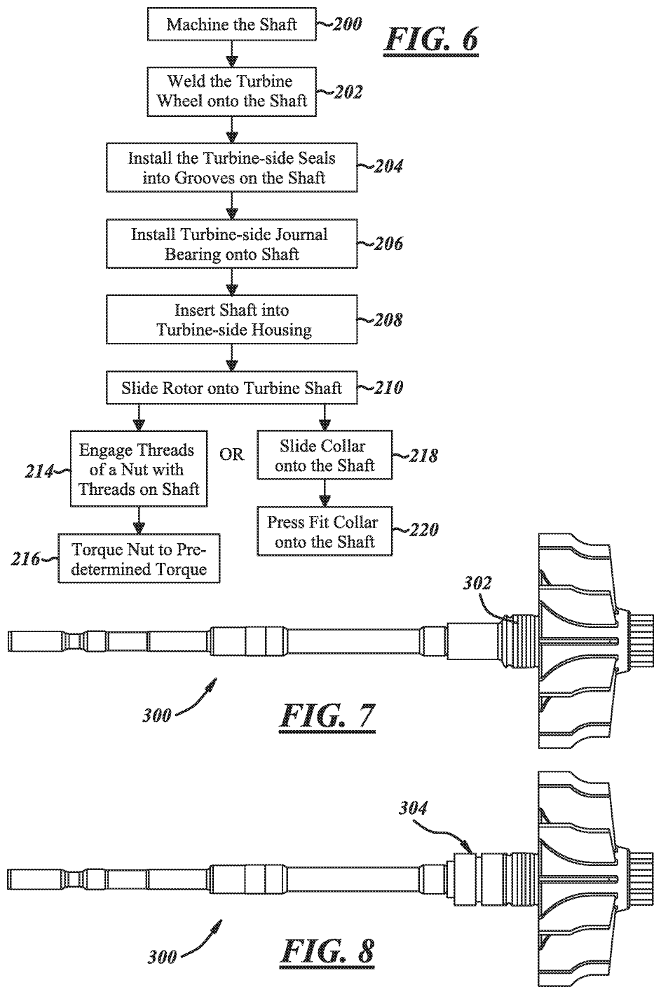

In FIG. 6, a portion of the assembly process is illustrated starting in block 200 with machining of the shaft of the machine. Various embodiments of the shaft are shown in FIGS. 2-4. The various cutbacks, grooves, tapers, shoulders, threads, etc. with the desired surface roughness are provided on the shaft. The turbine wheel is welded to the shaft in 202. In block 204, the turbine-side labyrinth oil seals are installed into the grooves provided on the shaft. These are similar to piston rings in that they are of a diameter slightly larger than the bore into which they are placed and they have a gap, which becomes minimal when the ring is forced into the bore. The gap of one ring is placed onto the shaft diametrically opposed from the gap of another ring. The path of escape for the gases is complicated, thus the term labyrinth is applied. Labyrinth oil seals provide one non-limiting example; other seal or seals may be used in place of such oil seals. In block 206, the turbine-side journal bearing is installed onto the shaft. In block 208, the shaft is mounted in the turbine-side of the housing. The rotor is slid onto the turbine shaft in block 210. In one embodiment in block 214, threads of a nut are engaged with threads machined on the shaft. The nut is torqued to the predetermined torque in block 216. Alternatively, a collar is slid onto the shaft. (Heating of the collar and/or cooling of the shaft may precede block 218.) The collar is press fit into place to retain the rotor of the electric motor in block 220. The shaft may be in tension during such process to provide a desired level of tension in the shaft by the press fit collar. An outer edge of the collar may contain a groove parallel to a central axis of the groove that can be used to break the collar for embodiments in which the collar is a sacrificial element.

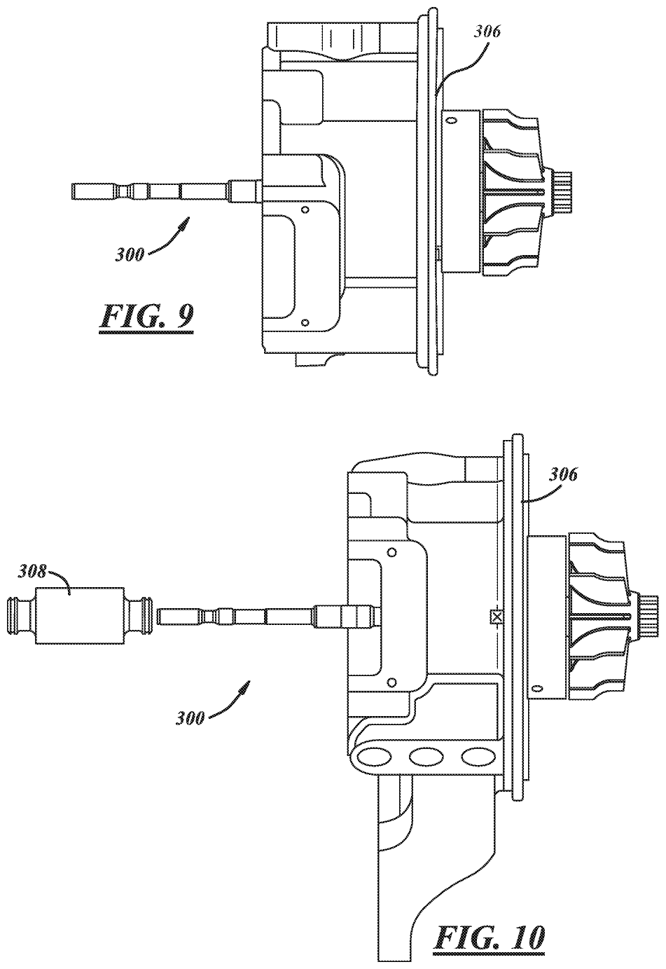

In FIG. 7, turbine-side, labyrinth oil seals 302 are shown installed into grooves in shaft 300. In FIG. 8, turbine-side journal bearing 304 is slid onto shaft 300. In FIG. 9 a turbine-side portion of the housing 306 is slid over shaft 300. Referring now to FIG. 10, rotor 308 is shown prior to sliding over shaft 300. In FIG. 11, rotor 308 is on shaft 300 and nut 310 is ready to be placed over shaft 300 and then engaged with threads machined into shaft 300.

In the embodiments in FIGS. 1-5 and 7-11, the rotor is provided with a rotor core. Not only does the stiffener shaft cause greater stiffness, it allows for the rotor to be assembled, including the permanent magnets, prior to placing over the shaft. However, in an alternative embodiment, the rotor may be assembled directly onto the shaft, such as shown in FIG. 12. Such a configuration may be appropriate when a very compact assembly is desired. Shaft 800 has end caps 802 between which permanent magnets 804 are placed with an outer containment sleeve 806 provided radially outwardly of permanent magnets 804. FIG. 12 does not show a retaining feature or a cutback as shown in other embodiments of the disclosure. Features of the rotor (i.e., elements 802, 804, and 806) in FIG. 12 can be used in any of the embodiments described above.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. An electronically-controlled turbomachine (ECT), comprising:
a shaft having a turbine wheel affixed thereto at or adjacent to one end thereof, a retaining feature in the form of a shoulder or a plurality of splines defined radially about the shaft between the turbine wheel and an end of the shaft opposite the one end thereof,
a rotor of an electric motor received on the shaft with one end of the rotor facing the turbine wheel configured complementary to and engaging with the retaining feature, and
a retaining element affixed to the shaft and abutting the rotor on an end of the rotor opposite the one end thereof.

2. The ECT of claim 1, wherein the retaining feature is the shoulder and the shoulder is machined into the shaft,
and wherein the one end of the rotor is configured to be perpendicular to a central axis of the shaft,
and wherein the one end of the rotor bears against the shoulder.

3. The ECT of claim 2, wherein at least one of a surface of the shoulder and the end of the rotor proximate the turbine wheel is roughened.

4. The ECT of claim 3, wherein the at least one of a surface of the shoulder and the end of the rotor proximate the turbine wheel is roughened by one of knurling, bead blasting, etching, sand blasting, laser vapor deposition, laser etching, and applying a coating.

5. The ECT of claim 2, wherein the shaft includes threads defined therein along a portion of the length of the shaft and the retaining element is a nut that engages with the threads of the shaft.

6. The ECT of claim 5, wherein at least one of a surface of the nut facing the rotor and the end of the rotor opposite the one end thereof is roughened.

7. The ECT of claim 6, wherein the at least one of a surface of the nut facing the rotor and the end of the rotor opposite the one end thereof is roughened by one of knurling, bead blasting, etching, sand blasting, laser vapor deposition, laser etching, and applying a coating.

8. The ECT of claim 2, wherein the retaining element is a collar that is press fit onto the shaft.

9. The ECT of claim 8, wherein the collar is a sacrificial element that is destroyed in disassembling the rotor from the shaft.

10. The ECT of claim 1, wherein the retaining feature is the plurality of splines defined radially about the shaft,
and wherein the one end of the rotor defines a plurality of fingers configured to engage with the plurality of splines of the shaft.

11. The ECT of claim 10, wherein the shaft includes threads defined therein along a portion of the length of the shaft and the retaining element is a nut that engages with the threads of the shaft.

12. The ECT of claim 11, wherein at least one of a surface of the nut facing the rotor and the end of the rotor opposite the one end thereof is roughened.

13. The ECT of claim 12, wherein the at least one of a surface of the nut facing the rotor and the end of the rotor opposite the one end thereof is roughened by one of knurling, bead blasting, etching, sand blasting, laser vapor deposition, laser etching, and applying a coating.

14. The ECT of claim 10, wherein the retaining element is a collar that is press fit onto the shaft.

15. The ECT of claim 14, wherein the collar is a sacrificial element that is destroyed in disassembling the rotor from the shaft.

16. The ECT of claim 1, wherein the shaft is cut back along a recessed portion extending at least partially between the one end of the rotor that engages with the retaining feature and the end of the rotor opposite the one end thereof abutted by the retaining element.

17. The ECT of claim 1, wherein the rotor comprises:
a rotor core received on and engaging the shaft, and
a plurality of permanent magnets installed against an outer surface of the rotor core.

18. The ECT of claim 17, wherein the rotor further comprises an outer containment sleeve coupled to the rotor core over the plurality of permanent magnets, the outer containment sleeve containing the plurality of magnets against the rotor core.

19. The ECT of claim 17, wherein the rotor core comprises a stiffener sleeve.

20. The ECT of claim 1, wherein the rotor comprises:
end caps received on and engaging the shaft, the end caps spaced apart from one another along the shaft,
a plurality of permanent magnets installed between the end caps against an outer surface of the shaft, and
an outer containment sleeve coupled to the end caps over the plurality of permanent magnets, the outer containment sleeve containing the plurality of magnets against the shaft.
